(19) United States
(12) Patent Application Publication
(10) Pub. No.: US 2002/0147850 A1
(43) Pub. Date: Oct. 10, 2002

(54) Electronic survey tool and dynamic workflow tool

(76) Inventors: Gregory W. Richards, Broomfield, CO (US); Joseph James Hildebrand, Littleton, CO (US); Kristofer D. Luke Syverstad, Aurora, CO (US); Scott Allen Daub, Littleton, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 09/827,303

(22) Filed: Apr. 5, 2001

(51) Int. Cl. G06F 15/16

(52) U.S. Cl. 709/248

(57) ABSTRACT

Disclosed is a method and system for knowledge and information sharing. Disclosed embodiments include a central electronic information network and a plurality of portable client devices for use by mobile personnel in the field. The electronic information network has a central database that contains data objects in the form of logic trees representing the cumulative knowledge and information regarding a plurality of situations that are expected to be encountered by the mobile personnel while in the field. These logic trees represent diagnosing algorithms, survey questions, and/or troubleshooting instructions that can be given to help field personnel recognize appropriate question sets to use in a particular situation and how to ask those questions in a logical manner. To provide access to the logic trees whenever necessary, logic tree data objects are also stored electronically on each of the portable client devices. Intermittently and preferably wirelessly, such as whenever a given client device connects to the central network for any reason, each client device synchronizes its logic tree data objects with those in the central database. In this manner, recent updates to the cumulative knowledge or information owned by a particular organization and stored in the central database can be reflected in all field personnel's client devices during offline sessions without the need for a wire-line communication connection or a manual synchronization.

### BACKGROUND OF THE INVENTION

1. Field of the Invention

The present invention relates to electronic tools for providing information resources to and obtaining feedback from a mobile remote workforce. More particularly, the present invention relates to a method and system for providing up to date information resources to each member of a remote workforce, and also for obtaining response information from the workforce wherein relevant data is transferred wirelessly in a manner that can approximate real time data access.

2. Discussion of the Related Art

Various organizations and occupations rely heavily upon the ability of a particular person or persons to gather relevant facts or data pertaining to a particular situation and then to apply a series of rules, algorithms or troubleshooting processes to those facts and data on the spot in order to identify a solution for achieving a particular goal. As tasks become more and more complex, as is increasingly the case in high technology industries, it however becomes more difficult for such persons to remember completely what facts and data are relevant to a particular situation, and what to do once the relevant data is identified. For example, a computer field engineer who travels to a client site to fix a problem on the client's computer system must be able to ask the appropriate diagnostic questions, identify what the problem is from the answers to the diagnostic questions (and any necessary follow-up questions), and then apply appropriate remedial actions to correct the problem. While this may appear to be a simple task, as will be readily appreciated by those skilled in the art, it is very difficult for such persons, such as field engineers, to remember how to diagnose and respond to every potential situation.

Traditionally, field engineers, technicians, and other persons performing similar troubleshooting functions relied heavily upon their prior experiences and training to be able to properly identify and remedy problems in such situations. However, one cannot expect field personnel to retain the information for all potential scenarios simultaneously. Frequently, to assist field personnel in having the most up to date knowledge, each such person therefore would be issued a field manual containing technical information and descriptions of potential solutions frequently encountered situations. Such field manuals were often updated on a periodic basis or as significant new information or situations were identified. In order to keep field manuals small and portable (and thus able to be brought to client sites), often they by necessity do not contain information for all potential situations. Furthermore, since each person's field manual must be updated individually, often a slow and laborious process typically entailing circulating paper notices (or alternatively circulating soft copies of the update such as copy encoded on a CD-ROM) to all field personnel, the manual may contain inaccurate or outdated information and thus does not provide field personnel with the benefit of their organization's current knowledge and newest information.

Thus, traditional mechanisms are lacking in their ability to keep field personnel apprised of all, and especially newer, potential situations because they still rely heavily upon each person's individual ability to retain any necessary information and recall and apply the information on the spot at the appropriate time. In some applications, the use of distributed computer networks (including the Internet and World Wide Web) and centralized information databases has helped to alleviate this problem. First, a central computerized database of information is relatively easy to update and, using contemporary computer networking technologies known in the art, many individuals can simultaneously be given electronic access via networked computers. Thus, the knowledge and information accessible by each individual person is always complete and up to date whenever they are consulted by personnel (unlike field manuals). In essence, each member of the organization has their own constructive copy of the information contained in the central database so long as they have access to a computer networked to their organization's network system.

Unfortunately, this contemporary centralized database and distributed computer network approach to knowledge and information sharing among members of an organization has heretofore not been adequately adapted for use by mobile field personnel. Predominantly, distributed computer networks require each user to have a client computing device with an electronic wire-line communication connection (such as a local LAN, Ethernet, ISDN, or telephone modem) to a central network server. Current mobile computing devices, such as notebook computers, are highly powerful, portable, and thus generally suitable for use as client computing devices on central networks in most situations. However, the requirement for each client computing device to be tethered to a wire-line communication connection has proven problematic for organizations that rely heavily upon mobile field personnel. In many situations, it is simply not plausible or convenient for field personnel to have access to a wire-line communication connection while they are performing their duties.

In order to free network users from the need for wire-line connections when using portable client computing devices like laptop computers and personal digital assistants (“PDAs”), technologies such as cellular modems and micro-cellular data networks are often employed. Using these technologies, network connections can be made using cellular telephony and other radio frequency (“RF”) network technology such that users are thus provided with mobile wireless access to certain types of information on their central networks. While these technologies are improving daily and are providing a potential alternative to wire-line connections in certain situations, they still have several drawbacks. The low bandwidth constraints imposed by current cellular voice network technology inherently limits the type of wireless data transfers that can use that technology. Additionally, with respect to digital wireless data networks such as cellular digital packet data (“CDPD”) networks, while these networks now offer data transfer rates up to 19.2 Kbps, their effective service areas are limited, indoor reception is poor, and often there is not reliable quality of service within those limited service areas. Thus, these technologies still do not allow organizations that have mobile field personnel to benefit from centralized data because current mobile wireless client computing devices cannot provide consistent data access since it is difficult or impossible for the device to remain online and provide real-time access to knowledge or information stored in the central electronic database.

Periodic synchronization, or “synching,” of data stored on a mobile client device with information stored in a non-mobile computer database is another approach for distributing information electronically to mobile computing devices or collecting information from them. In this approach, users carry electronically stored information of interest on their mobile devices and update the information from another electronic source. Synching is predominantly employed with PDAs and other mobile computing devices and entails periodically, such as once daily, connecting the mobile device to a centralized database (such as one located the hard drive of a personal computer) with a cradle. After this connection is established, only any new information on either the mobile device or computer is automatically transferred to the other device. Thus, a duplicate copy of desired information or data is stored on each device, and the mobile device is always up to date, or “synchronized,” as of the last time mobile device and centralized database were connected.

Some organizations have adopted synching-based approaches to help obtain information from their workforce. In particular, shipping companies use hand-held electronic devices having barcode scanners to read and record the status or location of particular items within their shipping chains. Whenever these hand-held scanning devices are synched by dropping it in a storage cradle at the end of a shift, the devices upload and update the current location of in transit items within a central searchable database.

The synching approach, however, is not readily adaptable to use for providing up to date information resources to remote members of a mobile workforce. Notably, the synching of mobile devices is largely a manual task that mobile personnel often either forget or don't have the opportunity to do regularly. The realization of up to date knowledge and information sharing is not achieved without this manual process. Thus, there is a significant chance that mobile field personnel will not have electronic access to the most current knowledge or newest information available to their organization when that information is needed.

Thus, there remains a need in the art for an improved system and method for providing information resources to and obtaining feedback from a mobile remote workforce that overcomes the above-described and other disadvantages inherent in the prior art.

### SUMMARY OF THE INVENTION

Accordingly, the present invention is an improvement over prior art systems and methods for providing up to date information resources to remote members of a mobile workforce.

In light of the above and other drawbacks inherent in the prior art, it is an object of the present invention to provide an electronic information and knowledge sharing system and tool for use with a mobile workforce wherein the system and tool automatically provide electronic access to near real-time information and knowledge stored in a central database in an offline mode without the need for manual updating.

Further, it is an object of the present invention to provide an electronic computing tool that is adapted to receive frequent updates of information from a central database and to use that information in assisting field personnel in gathering data regarding, diagnosing and correcting a variety of potential situations.

Additionally, it is an object of the present invention to provide an electronic survey tool that is adapted to receive intermittent updates of instructions wirelessly from a central database and to interpret those instructions to generate appropriate inquiries for field personnel to use in gathering data regarding, diagnosing and acting appropriately in response to a variety of potential situations.

Additional objects, features and advantages of the invention will be set forth in the description that follows, and in part will be apparent from the description, or may be learned by practice of the invention. The objectives and other advantages of the invention will be realized and attained by the exemplary embodiments particularly pointed out in the written description and claims hereof as well as in the appended drawings.

To achieve these and other advantages and in accordance with the purpose of the present invention, as embodied and broadly described, electronic systems for knowledge and information sharing include a central electronic information network having a central database and a plurality of portable client devices for use by a mobile personnel in the field. The central database contains data objects in the form of logic trees that represent the cumulative knowledge and information regarding a plurality of situations that are expected to be encountered by the mobile personnel while in the field. These logic trees represent diagnosing algorithms, survey questions, and/or troubleshooting instructions that can be given to help field personnel recognize appropriate question sets to use in a particular situation and how to ask those questions in a logical manner. To provide access to the logic trees whenever necessary, logic tree data objects are also stored electronically on each of the portable client devices. Intermittently and preferably wirelessly, such as whenever a given client device connects to the central network for any reason, each client device synchronizes its logic tree data objects with those in the central database. In this manner, updates to the cumulative knowledge or information owned by a particular organization and stored in the central database is reflected in substantially all field personnel's client devices without the need for a online communication connection or a manual synching.

Additionally, the logic tree data objects can instruct the client device to store any information or data obtained and entered by the field personnel in response to prompting by a particular logic tree. Later, when the client device is synchronizing with the central information network, this data can be uploaded to the central information network and electronically stored for data tracking and later analysis, research or other suitable uses. In this manner, not only is the cumulative knowledge of an organization pushed down to individual field personnel in a rapid manner, but information flow is also provided back in the opposite direction for use by the organization as a whole.

Portable client devices according to the present invention are portable electronic communication devices that include software for storing and interpreting logic tree data objects and processing various inputs as defined by the data objects, visual display means for providing appropriate information to personnel, manual input means for accepting data from the personnel, and communication means for connecting to and synchronizing with the central network. Preferably, the portable client devices are PDA-type computing devices having at least a touchscreen display for input and output to and from field personnel and a wireless communication modem for transferring data to and from the central network on an intermittent basis. More preferably, these PDA client devices further include a wire-line modem, an optical barcode scanner, and additional software adapted to provide standard PDA business functions as is known in the art including email, web browsing, and electronic organizer capabilities.

In preferred embodiments, the invention can include the use of client devices having automatic diagnostic capabilities. These preferred client devices would obtain relevant information using a local connection to an external electronic device or computer network. Preferably, the local connection allows a user to download configuration information of the external electronic device to his or her portable client device. This configuration information is then analyzed, recognized and processed automatically on the client device using the latest version of the logic trees resident therein. After this automatic diagnostic is complete, appropriate follow-up questions and/or remedial instructions could be provided to the field personnel.

Additionally, in other preferred embodiments, local connections to such external electronic devices can be used to pass information from the central network to the external electronic device via the client device.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention. In the drawings:

FIG. 1 is a schematic diagram depicting the elements and relationship of the central network and the remote client devices according to embodiments of the present invention; and

FIG. 2 is a schematic diagram of a portable client device in the form of a PDA-type field information appliance according to preferred embodiments of the present invention; and

FIG. 3 is a flow diagram depicting the process whereby a portable client device synchronizes its locally stored information with that information stored on the central network according to embodiments of the present invention.

### DETAILED DESCRIPTION OF THE PREFERRED EMBODIMENTS

Reference will now be made in detail to the preferred embodiment of the present invention, examples of which are illustrated in the drawings. While the present invention has various applications to many different organization types, it will be readily appreciated by one skilled in the art that it has particularly useful applications for use by a workforce of field engineers, and specifically in the high technology industry by computer technicians, who spend a great deal of time performing complex tasks away from a standard office setting. The use herein of the terms “field engineer,” “computer technician,” “field personnel,” “user” and the like are intended to merely illustrate operation of the present invention in connection with certain exemplary users and do not limit the present invention to particular fields of use.

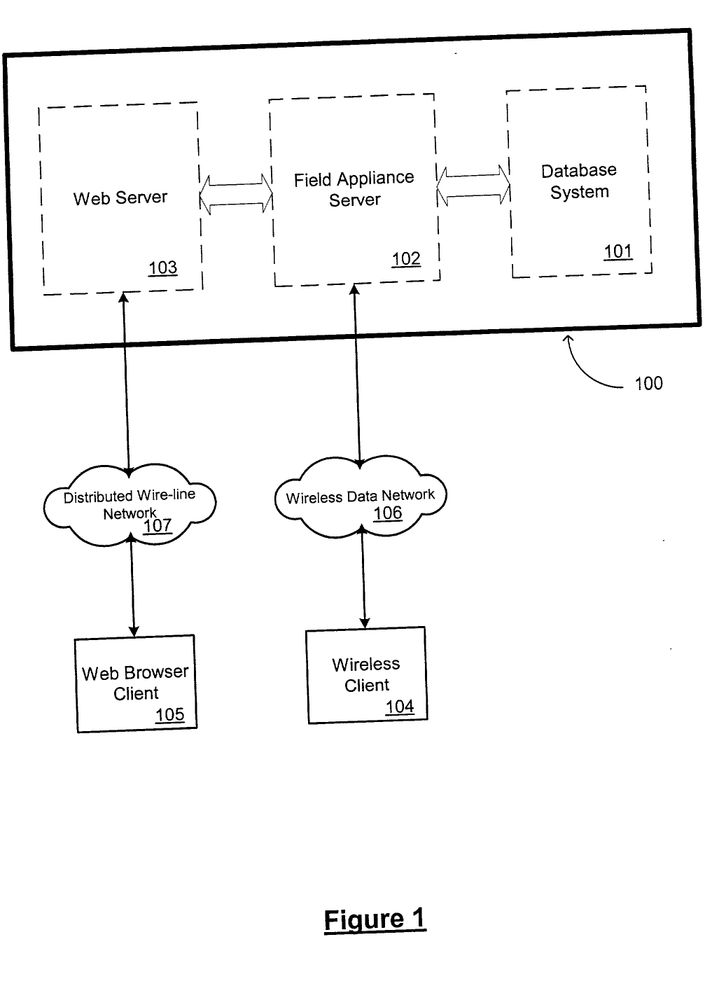

FIG. 1 schematically depicts an electronic system for knowledge and information sharing according to one embodiment of the present invention. As shown in the figure, the system includes a central electronic information network 100 having a database system 101, and a plurality of client devices 104 and 105 for use by mobile field engineers. The central database contains data objects in the form of logic trees that represent the cumulative knowledge and information regarding a plurality of situations that are expected to be encountered by any field engineer. These logic trees encode diagnosing algorithms, survey questions and troubleshooting instructions that can be given to help field personnel recognize appropriate question sets to use and how to ask those questions in a logical manner.

All knowledge and information is organized in the central database system 101 logically into a series of cascading questions that are arranged to provide intelligent navigation to the appropriate diagnostic steps and actions that should be taken by the field engineer. The use of logic trees, as will be appreciated by one skilled in the art, allows for navigation rules to be stored and organized in a logical manner whereby potential answers to an initial question automatically direct the user to one or more other follow-up or related questions until a diagnosis is made. This thereby enables intelligent navigation to the appropriate stored information or knowledge for many circumstances. For example, a field engineer is first asked to identify and input the part number for the item that he is servicing. After receiving the part number, the client device software progresses down the logic tree to identify several questions relating to that part type.

To provide access to the logic trees whenever necessary, logic tree data objects are also stored electronically on each of the portable client devices. Intermittently, such as whenever a given client device connects to the central network for any reason, and preferably with a portable client device wirelessly via a wireless data network 106 (i.e., as a wireless client 104), each client device synchronizes its logic tree data objects with those in the central database. In this manner, updates to the cumulative knowledge or information owned by a particular organization and stored in the central database system 101 is reflected in field personnel's client devices in near real-time without the need for a wire-line communication connection or a manual synching. In operation, a field engineer encounters a particular situation and starts the logic tree interpretation software on his or her client device, the software loads a wake up process, obtains initial diagnosing data from the field engineer after some directed prompting from initialization logic (or automatically as described below), and locates any appropriate logic trees for the encountered situation. As is known in the art of object based programming, any logic tree data object according to the present invention can internally refer to another data object such as by passing values to a second root node, i.e., the root node of another logic tree, whereby one tree can essentially be represented as a sub-tree of another.

Example 1 below describes a scenario employing intermittent updating of wireless clients according to embodiments of the present invention.

### EXAMPLE 1

Through the combined experience of many field engineers and resulting laboratory experiments, an electronics servicing company learns that if a repair technician pushes on a particular corner of a connector (part number 11432) during assembly, the connector pins will break and produce a faulty electronic connection. The logic tree data object for part number 11432 is then updated in the central database. The updated data object contains a flag that issues a warning to field engineers whenever the logic tree for part number 11432 is invoked instructing them to not push on the corner for fear of bending the connector pins. Additionally, if a faulty connection is identified as a symptom in response to diagnostic questions the logic tree will instruct the field engineers to check each number 11432 connector to see if the pins are broken. Any altered data objects will then be downloaded to each portable client device the next time they connect to the central network for any reason, and this information will thereby be shared with all members of the work force in near real-time.

As detailed in the above example, only data objects that have been changed since the device's last synchronization (i.e., are different than the objects stored locally on the client device) are transferred to the client. One skilled in the art will readily appreciate that this methodology is especially suitable for wireless communications because the transfer of only those discrete objects that have been altered minimizes the connection time and traffic required for each session.

In embodiments of the present invention, the logic tree data objects not only provide instruction via the client device to a field engineer regarding knowledge or information stored in the central database system 101. One or more logic trees can serve as a surveying mechanism that can beneficially request and obtain information or data from field engineers whenever certain situations are encountered. Example 2 below details how such a surveying mechanism would operate.

### EXAMPLE 2

Upon studying a series of failures in the field for a particular memory chip configuration, the research and development team for an organization postulates that the chip is failing due to high operating temperatures caused by poor ventilation. The team updates the logic tree data object stored in the central database system that pertains to the memory chip in question. The new logic tree, once downloaded onto a client device and implemented, asks each field engineer that encounters such a memory chip on a work site to report the operational status of the chip and the type of ventilation to which the chip has been exposed. After receiving some data back from the field engineers, the research and development team concludes that heat ventilation has not been a problem, so they change the logic tree data object to have field engineers collect data to test a new postulation (such as faulty connectors, humidity, etc.).

As shown above in the example, the data sharing features of the present invention allows organizations to instruct field engineers regarding the collection of data from the field in near real-time. Portable wireless client devices 104 store any relevant information or data entered by the field engineer as prompted by the logic trees, and this data from the field engineer is later uploaded to the central information network 100 during the next connection to the network 100 and the resulting synchronization session. Here, the data is electronically stored in database system 101 for data tracking and later analysis, research or other suitable uses.

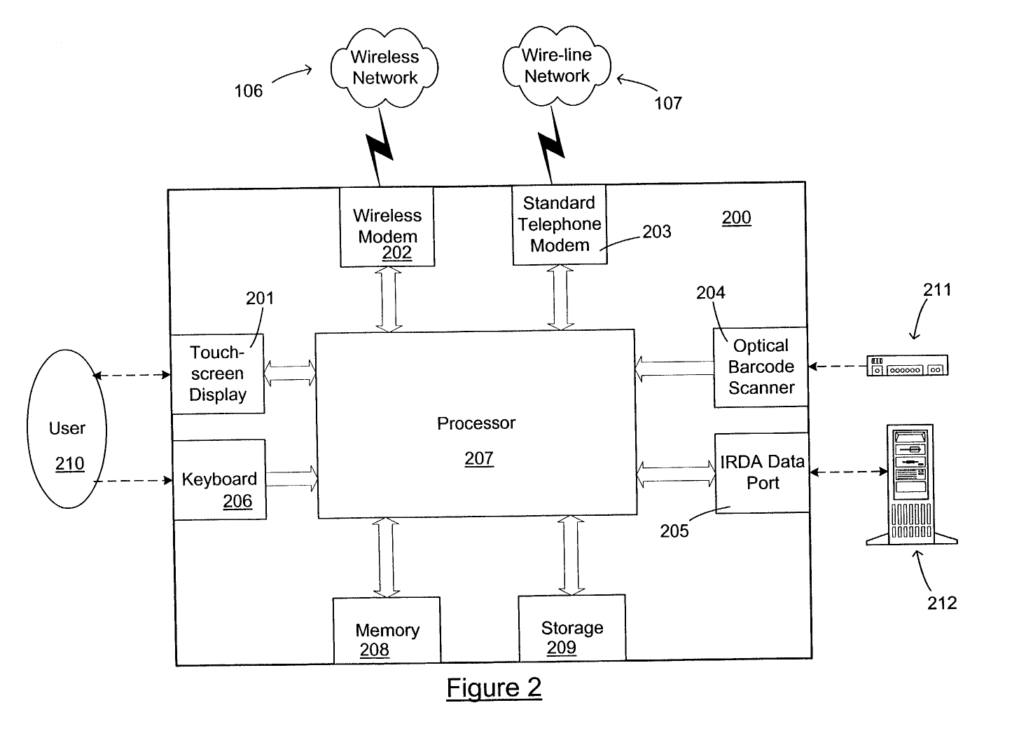

Suitable client devices according to the present invention include portable electronic communication devices that comprise software for storing and interpreting logic tree data objects and processing various inputs as defined by the data objects, visual display means for providing appropriate information to personnel, manual input means for accepting data from the personnel, and communication means for connecting to and synchronizing with the central network. Preferably, these portable communication devices are in the form of an integrated PDA-type computing device referred to herein as a field information appliance (“FIA”). Depending upon how a portable client device connects to the network 100, the FIA is depicted generally in FIG. 1 as a wireless client 104 or a web browser client 105. FIG. 2 provides a schematic diagram of a preferred FIA 200 that can be used advantageously in embodiments of the present invention.

FIA 200 has a touchscreen display 201 for input and output to and from the user 210 and a wireless communication modem 202 for transferring data to and from the central network on an intermittent basis. Depending upon the type of wireless data service utilized, this wireless modem can be adapted to work according to any wireless network 106 standard including CDPD, GSM, GPRS, CDMA, W-CDMA and I-mode as well as wireless LANs. While not required, each FIA additionally includes a traditional high-speed wire-line modem 203 such that the central network 100 can be contacted via a traditional telephone line dial-up. Not only does the inclusion of wire-line modem 203 serve as a backup communication and synchronization mechanism over a wire-line network 107 (such as a the Internet via a dial-up ISP) whenever wireless network 106 service is unavailable, but this also allows the FIA, if equipped with web browsing functionality, to operate in an online mode as a web browser client 105 (see FIG. 1) as described in detail below. Additionally, preferably FIA 200 further includes an optical barcode scanner 204 for reading barcoded input (such as from a product number label 211 on a piece of equipment being serviced), a “QWERTY” detachable keyboard 206 for accepting alphanumeric input from a user 210, and an IRDA standard infrared data port 205 for transferring data to and from other IRDA port equipped electronic devices 212.

Each FIA 200 includes a digital processor that interacts with the above-described input and output devices, a memory 208 and storage 209 (which may include removable storage such as PCMCIA and compact flash cards/drives or the like) with an operating system suitable for supporting networking and interface applications as herein described and business applications as are commonly found on PDAs as is known in the art, such as those that provide email, web browsing, electronic organizer programs, etc. In most preferred embodiments of the present invention, the FIA 200 has a Linux operating system that supports a Java® based user interface. This Java interface, in turn, accepts extensible markup language (“XML”) data objects from the central network 100 during synchronization via the field appliance server 102 (see FIG. 1) and stores those data objects either in storage 209 or in memory 208 for later interpretation and use when needed by the field engineer. As will be readily appreciated by one skilled in the art, the use of a Linux operating system, Java interface scripting, and XML data objects provides a client structure that is particularly suitable for PDA-type portable computing devices. Specifically, since the XML data objects completely define the knowledge and information contained in the central database system 101, the Java based software running on processor 207 needs only to provide presentation logic. Additionally, due to the inherent ability of XML-defined data to be converted readily into various other data formats, including HTML via extensible style language (“XSL”), the data can be shared across numerous platforms, including with standard web browser clients 105 via web servers 103. Additionally, tokenized strings, as is known in the art, can be used in addition to XML to provide certain performance improvements.

Referring again to FIG. 1, as will be readily appreciated by one skilled in the art, the FIA software can optionally be adapted to run both without a connection to the field appliance server 102 during active use by a field engineer (offline as with the intermittently updated wireless client 104 as described immediately above) or with a concurrent connection to the central network 100 field appliance server 102 via a web server 103 and a distributed wire-line network 107 like the Internet (i.e., as a web browser client 105 operating online). Additionally, to provide field engineers with added flexibility, they could be provided with password protected access as a web browser client 105 such that they may use a web browser running on any computer connected to the Internet (as well as a FIA 200 connected via a dial-up/wireless ISP, etc.). Web server 103 will communicate with field appliance server 102 to obtain XML code from the database system 101 and serve that code dynamically over the Internet to the web browser client 105 (either as XML code or after converting the XML into HTML). Thus, through web server 103, a field engineer will additionally be able to access the contents of the central database system 101 in real-time with either a PC (and a password protected secure login) or a FIA so long as a networking connection (telephone line, LAN, CDPD network signal, etc.) is readily available for commencing an online session.

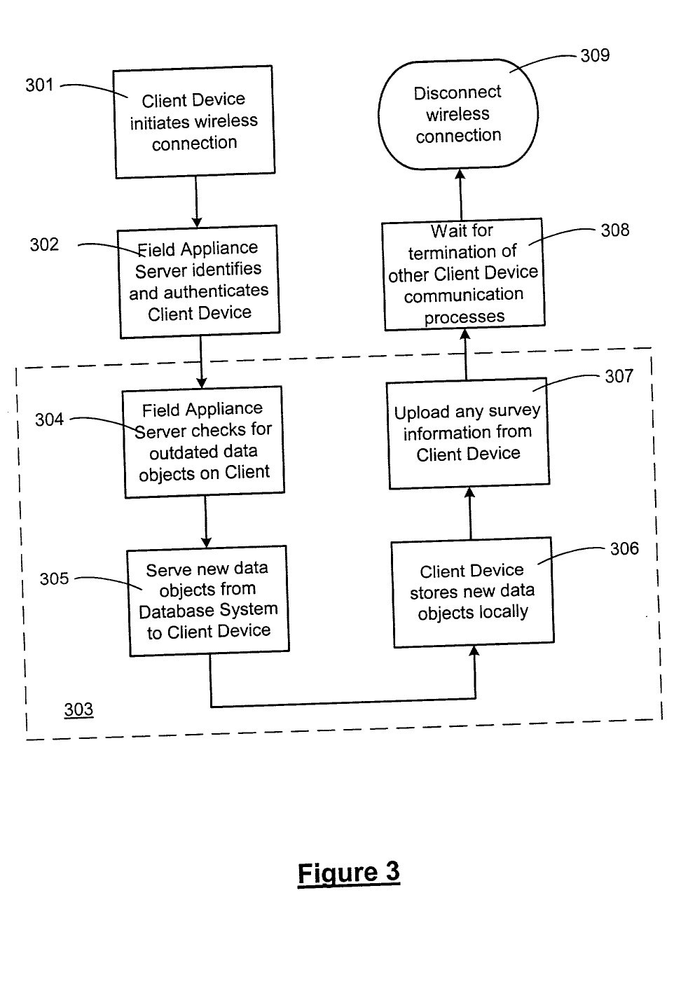

FIG. 3 depicts the steps whereby a mobile client device a synchronizes its locally stored information with that information stored on the central network according to embodiments of the present invention. Generally, the client device first initiates a wireless connection 301 to the central network. This connection does not need to be made by the user for the express purpose of updating the data on his or her client device, but additionally includes whenever the user initiates wireless sessions for any purpose such as the collection of email, reception of electronic dispatches, or for web browsing (whether that be for online access to the logic tree data objects or not). The field appliance server recognizes any such wireless session, and identifies and authenticates the client device 302. After identifying the client device, the field appliance server initiates a synchronization session 303 that downloads all new logic tree data objects to the client device and uploads any survey information from the client for storage. This synchronization session preferably is run in the background on the client device such that the user is unaware that the synchronization is taking place. For example, while a user connects with his portable client device to check his email, the synchronization occurs automatically (if needed) without any direction or actions on his part.

After the synchronization transfers are complete, the device waits 308 to see if the user is running any other applications that require the wireless connection (such as if he was still surfing the web), and then, after all applications requiring a communication connection have ended, it disconnects 309 from the network.

One of ordinary skill in the art will readily appreciate that many different synchronization methodologies can be employed in embodiments of the invention. The synchronization 303 detailed in FIG. 3, comprising steps 304 through 306, follows just one of many possible methodologies. As shown in the figure, the synchronization 303 begins by the field appliance server checking for outdated data objects on the client device 304. This step could be performed in various ways, including checking a synchronization status log kept in a database on the central network, identifying when the last time the client device synchronized and identifying data objects that have since been updated, deleted or created, or simply comparing the contents of the client device with the information stored in the central database system.

Once the appropriate new data objects have been identified, the field appliance server downloads 305 the new data objects from the database system to the client device. The client device then stores the new objects locally 306 for use offline whenever necessary, and proceeds to upload any survey information it has collected since its last synchronization 307.

In preferred embodiments, the invention can include the use of data objects and client devices having automatic diagnostic capabilities encoded therein. In these preferred embodiments, client devices would obtain relevant diagnostic input data using a local connection to an external electronic device or computer network (e.g., a third party's computer network that is not electronically connected to the central network 100). Preferably, this local connection comprises standard IRDA infrared ports on both the client device (such as IRDA data port 205 of the FIA 200 as in FIG. 2) and external electronic device (element 212 of FIG. 2) that downloads configuration information of the external electronic device onto the client device. Optionally, of course, other communication means including Bluetooth, radio bar codes, LAN and hard wiring (USB, RS232) could be incorporated into the FIA for communicating with various different external electronic devices. This downloaded configuration information is then analyzed, recognized and processed automatically on the client device using the latest version of the logic trees resident therein. After this automatic diagnostic is complete, appropriate follow-up questions and/or remedial instructions could be provided to the field personnel. Additionally, this diagnostic information can be retained in the client device and later uploaded to the central network (as in step 307 in FIG. 3) at the next synchronization for further analysis or as part of a field survey.

As with other embodiments of the invention, and data objects that define the actions taken by a client device during automatic diagnostics are updated at each opportunity. Whenever a client device connects to the central network for any reason, the synchronization process will occur and will ensure that that client device is provided with the most recent data objects. In this manner, any diagnostic that is being performed while the client device is offline is always as recent as the last time the client device went online (whether wirelessly or through a wire-line mechanism) with the central network.

Additionally, in other preferred embodiments, local connections to such external electronic devices can be used to pass information from the central network to the external electronic device via the client device.

### EXAMPLE 3

A field engineer has a FIA of the type depicted by FIG. 2 that includes an IRDA port (or other suitable two-way data transfer means) for exchanging data with remote computers and electronics equipment. During its last synchronization with the central network, the field engineer's FIA downloaded and stored locally a data object containing a software key code. This key code operates as a digital certification that the field engineer has been trained and is qualified to service a particular type of network server (or software). Henceforth, whenever the field engineer uses this FIA to connect to this particular type of network server via infrared (or other suitable means, such as a USB cable, etc.) for diagnostic purposes, the software code is transmitted to the server. This code then temporarily unlocks the server's configuration files such that they can be modified as necessary by the field engineer.

The preferred embodiments of the invention having thus being described, it will be readily apparent to one of ordinary skill in the art that many alterations, additions, and modifications to the embodiments of the invention may be made while still encompassing the spirit and scope of the present invention. Any and all such alterations, additions, and modifications are thus intended to be encompassed by the invention as claimed.

What is claimed is:

1. A method for sharing knowledge and information amongst a plurality of users that can be either online or offline, said method comprising:
compiling said knowledge and information into data objects, said data objects defining logic trees that represent the cumulative knowledge and information regarding a plurality of situations that are expected to be encountered by said users;
storing said data objects in a central database in a network; and
providing electronic access to said database with a plurality of client devices, said client devices being adapted to store locally a copy of each of said data objects for offline utilization by said users with said client devices wherein changes to any of said data objects stored in said central database are automatically reflected in said local copies of said changed data objects through a synchronization process that occurs whenever said client device accesses services provided by said network.

2. The method according to claim 1, wherein said synchronization process includes the step of uploading survey data stored in said client devices, said survey data having previously been collected in response to surveying instructions provided by one or more of said data objects.

3. The method according to claim 1, wherein said data objects define a diagnostic function such that said client devices are adapted to automatically analyze data obtained from an electronic source.

4. The method according to claim 1, wherein said data objects are encoded in said database using coding selected from the group consisting of extensible markup language and tokenized strings.

5. The method according to claim 1, wherein said client devices are adapted to access services provided by said network by connecting to said network over a wireless data network, and wherein said synchronization process occurs whenever said client devices connect to said network wirelessly.

6. The method according to claim 1, wherein said users can optionally connect to said network and utilize said data objects stored in said database in real-time.

7. The method according to claim 6, wherein said user connects to said network using a web browser.

8. The method according to claim 7, wherein said web browser is running on a device selected from the group consisting of an online wireless client device and a wired Internet connected device.

9. The method according to claim 1, wherein said synchronization process runs on said client device as a background process.

10. A system for sharing knowledge and information amongst a plurality of users that can be online or offline, said system comprising:
a central electronic information network having a database and a server, said database containing a plurality of data objects and said data objects defining logic trees that represent the cumulative knowledge and information regarding a plurality of situations that are expected to be encountered by said users; and
a plurality of portable client devices, said client devices each storing copies of said data objects locally for utilization by said users on demand, wherein
whenever a given client device connects to the central network for any reason, said given client device synchronizes its data object copies with those in the database such that any recent changes to said data objects stored in said database is reflected in said client devices' during offline sessions.

11. The system according to claim 10, wherein said logic trees define information types selected from the group consisting of diagnosing algorithms, survey questions, and troubleshooting instructions.

12. The system according to claim 10, wherein said portable client devices comprise mobile computing devices adapted to connect to said network over a wireless data network.

13. The system according to claim 12, wherein said client device has a touchscreen display and wireless communication hardware.

14. The system according to claim 10, wherein said client device has a local connection means for obtaining diagnostic input data from an electronic source, and wherein said data objects define a diagnostic function such that said client devices are adapted to automatically analyze data obtained from said electronic source.

15. The system according to claim 10, wherein said data objects are defined using coding selected from the group consisting of extensible markup language and tokenized strings.

16. The system according to claim 10, wherein said users can optionally connect to said network and utilize said data objects stored in said database in real-time.

17. The system according to claim 16, wherein said user connects to said network using a web browser.

18. The system according to claim 17, wherein said web browser is running on a device selected from the group consisting of an online wireless client device and a wired Internet connected device.

19. The system according to claim 10, wherein said data object copies are synchronized by a process that runs on said client device as a background process.

20. The method according to claim 10, wherein said client devices are adapted to access services provided by said network by connecting to said network over a wireless data network, and wherein each said client device synchronizes its data object copies whenever said client device connects to said network wirelessly.
